(19) United States
(12) Patent Application Publication
(10) Pub. No.: US 2023/0356839 A1
(43) Pub. Date: Nov. 9, 2023

(54) Special electric propulsion system to power paragliders and other small, light aircraft

(71) Applicant: Pete Bitar, Anderson, IN (US)

(72) Inventor: Pete Bitar, Anderson, IN (US)

(21) Appl. No.: 18/144,653

(22) Filed: May 8, 2023

Related U.S. Application Data
(60) Provisional application No. 63/339,489, filed on May 8, 2022.

(51) Int. Cl. B64D 27/24; B64C 31/024

(52) U.S. Cl. CPC B64C 31/024; B64D 27/24; B64D 2211/00

(57) ABSTRACT

An improved system of electrical, battery operated propulsion for use by an individual when engaging in paragliding, powered paragliding, paramotoring, hang gliding, and other similar sporting activities. The system includes a lightweight frame; at least one electrical driven, ducted turbine system made of at least one turbine, a shroud with a cut protector, and an electric motor; a seat assembly; a seat belt, and a pair of shoulder straps to hold user to the seat; a power system with a set of rechargeable batteries, battery boxes, a wiring harness from batteries to motors; and a servo-throttle for powering a motor of the system.

### CROSS-REFERENCE TO RELATED APPLICATIONS

This application claims the benefit of U.S. Provisional Pat. Application with Serial Number 63339489 filed May 8, 2022, by Pete Bitar. The provisional application is entitled “Special electric propulsion system to power paragliders and other small, light aircraft.”

### FIELD OF INVENTION

This invention relates to a Special electric propulsion system called a CanopE-Jet to power paragliders and other small, light aircraft. Particularly this relates to an apparatus and system for paragliders. As an improved means of propulsion for use by an individual when engaging in paragliding, powered paragliding, paramotoring, hang gliding, and other similar sporting activities. This relates to propulsion arrangements which can be secured to the pilot or seat for a pilot, and which gives the pilot controllable powered flight.

This is a personal air propulsion device for use by an individual and potential passenger. This could be used with snow skiing, skating, bicycling, or so-called “extreme sports” including skateboarding, snowboarding, surfing, power kiting and the like. The system relates, in general, to the use of single or clustered, high RPM electric ducted fans employing the Coanda effect to provide thrust for transportation systems and enabling component designs for vehicles such as ultralight aircraft, and, more particularly, to a flying entertainment vehicle. This invention relates to such devices that provide for hands-free operation and control of the device and are configured to accept adjustments for versatility. The multiple electric thrusters’ ducted fans can be made of carbon fiber for light weight and strength but can also be fabricated from a variety of other materials and the CanopE-Jet can fly for several minutes per charge, depending on the number of batteries and energy density of the batteries being carried.

### FEDERALLY SPONSORED RESEARCH

None.

### SEQUENCE LISTING OR PROGRAM

None.

### BACKGROUND-FIELD OF INVENTION AND PRIOR ART

As far as known, there are no Special electric jet propulsion systems to power paragliders and other small, light aircraft or the like. It is believed that this product is unique in its design and technologies.

Personal flight devices were developed in the 1960s and 1970s but were essentially rocket based devices (jet belts) which gave extremely short flight times (typically about 26 seconds) and were difficult to control. Further, these devices were fueled by rocket fuel which is intrinsically dangerous. More recently, a number of personal flight devices have been proposed which use ducted fans as their means of propulsion: — for example, a device which includes a pair of ducted fans, and which is steered by tilting the ducted fans relative to the pilot. A broadly similar type of design has been proposed, using shrouded propellers rather than ducted fans. Additionally, powered paragliders have been in production and use since the 1970s and 1980s using gas powered, propeller-driven systems. In the 2000s and 2010s, electric, propeller-driven systems have come into use, using single or multiple open propellers but still using a protective “loop” cage to prevent paraglider lines from entering the propeller.

A personal air propulsion device of sophisticated design is needed to power an individual over a chosen surface. The surface might be ice, snow, water, land, pavement, or any surface chosen. The device should provide lightweight air propulsion from an internal combustion engine powering a fan. Air should be expelled from the device in a way that further increases thrust. Until now, individual jet flight devices have been produced, but they have the disadvantage of being able to fly only a few minutes because they consume a large amount of fuel, which limits flight endurance and performance.

Paragliding equipment in general is well known and generally includes a harness section that a user secures to his body with loops and restraints to enable the user to be comfortably suspended in flight and move relatively freely, and a wing section (canopy) of fabric designed to act as an airfoil for slowing the rate of fall of a user and for capturing lift from thermal air movement. In use, the user is suspended below the canopy via suspension wires. Powered paragliding or paramotoring is also known, in which a paraglider mounts an engine or electric power source to his or her back to add power to the paragliding activity. Modern powered paramotoring gives pilots the ability to soar and stay airborne for hours using only rising air currents. Existing arrangements, however, suffer limitations on different aspects and create additional challenges for both the designers and the pilots. For instance, the added weight of some of these arrangements can require additional efforts from the pilot during takeoff, landing and in flight. It can also reduce the easiness of maneuvering the unit compared to an unpowered version. Still, the added weight can significantly modify the location of the center of gravity of the unit compared to the original powerless version. In some cases, redesigning the original paraglider may be necessary before providing it with a motor. Room for improvements always exists in this area of technology.

Present designs are either too small and underpowered to be used as a Personal Air Propulsion System, herein referred to as PAPS, or to bulky requiring far too big of a device to be convenient in most applications. Based on the foregoing, there is a need in the art for a lightweight design of a ducted fan propulsion which may be utilized in a wide range of applications.

New developments in small lightweight electric motors have focused on a system that is a ducted fans system for powering small ground vehicles the system is also applicable to aircraft, ground effect vehicles, manned or unmanned drones, water-based vehicles or personnel systems that require no vehicle at all. While current electric motors have very high power to weight ratios the associated power supplies, batteries and/or generators are much heavier and bulkier. Also, current propeller and ducted fan systems are fragile and potentially dangerous. This system is applicable whether the fan is used to provide propulsive thrust or vertical lift. A need exists for a lightweight, high thrust, zero emissions alternative transportation device that is safe from exposed propeller.

### Problem Solved

The improvement and problem solved as to Special electric propulsion system to power paragliders and other small, light aircraft includes: a lighter weight due to lighter electric motors than gas-powered systems; no fuel or Greenhouse Gas (GHG) emissions since it is all electric, battery powered; it has a small footprint and be transported in a standard car seat, trunk, or rear of an SUV; the craft has rapid setup for launch and rapid start and can result in faster potential airspeed, limited only by the speed limitation of the wing/paraglider, with potential, theoretical speeds of over 300 mph; has a smooth, low-vibration operation; uses ducted turbines with protected intakes and more than one ducted fan/turbine arrayed with counter-rotating propellers/turbines; and is a safer system with no exposed propeller blades which often can damage paraglider lines and other objects.

### Prior Art

As far as known, there are no devices for Special electric propulsion system to power paragliders and other small, light aircraft as described by Bitar. It is believed that this system or apparatus is unique in its design and technologies. A novelty search revealed:
A. U.S. Pat. 8,894,015 was issued to Contoret in 2014 for an Apparatus and method for paragliders. It demonstrates an Apparatus and method for propelling a user wearing paragliding equipment are disclosed. The apparatus includes at least one thruster for providing thrust in a predetermined direction; and an attachment element for attaching the at least one thruster to a user’s body such that the thruster is secured against the front portion of the user’s body.
B. U.S. Pat. 8,561,936 was issued to Matte in 2013 for a Hang glider electric propulsion system and method. Here is provided a system includes a keel fitting that can be rigidly attached directly to the keel of the hang glider. It also includes two elongated frame members symmetrically mounted on opposite sides of the keel fitting. At least one electrical motor is mounted on each frame member and there are at least two propellers, each in driving engagement with a corresponding one of the electrical motors. The system further includes an electrical power unit mounted on the back of the pilot. The electrical power unit includes at least one battery and a pilot-actuated control circuit to vary the electrical power supplied to the electrical motors. The system gives the pilot the capability of taking off from flat terrain. Once airborne, the system is not operated, and the hang glider can then be used as an unpowered one.
C. U.S. Pat. 7,484,687 was issued to Matte in 2009 for a Propulsion device. This teaches a personal flight device which consists of a housing securable to a pilot, at least one pair of fans, and at least one engine mounted on the housing for driving the fans; one fan of the pair is mounted to one side of the housing and the other fan of the pair is mounted to the other side of the housing; in use, both fans rotate in the same direction for producing thrust.
D. U.S. Pat. 7,179,141 that was issued to McMullen in 2007 for a Personal air propulsion device. This innovation was a backpack with backpack frame and adjustable shoulder harness removably fitting a person, the backpack further comprising an internal combustion engine with a pulley system connecting the engine to a propeller axle with propeller, a propeller surrounded with air intake and air outlet whereby the propeller propels a person upon a given surface. Handles comprise controls for throttle, kill switch, and lights. Handles are a part of the backpack frame or of ski poles. A pendulum emergency stop device kills the engine if the person falls.
E. U.S. Pat. 8,292,670 was issued to Burgess Jr., in 2012 for a Personal propulsion device with hands free control. Portrayed here is an improved personal propulsion device that generally imparts thrust directly to the user. The device allows hands free control of thrust magnitude and direction so both hands can grasp and control bicycle handlebars and brakes, watercraft paddles, ski poles or other apparatuses. The device is adjustable vertically, on the users’ back, higher to allow sitting in a canoe or wheelchair and lower for standing on skates, skis, kick scooters etc. In one embodiment, the device includes an air compressor that is operatively connected to a cam mechanism engaged with the propulsion mechanism to provide compressed air. In another embodiment, the device includes a gap control mechanism to reduce or increase the size of the air inlet gap between the lip of the propeller shroud and an air horn to decrease noise levels or increase propulsion. The air horn can be gradiently flexible and warp able to allow controlled movement thereof.
F. U.S. Pat. 5,222,569 was issued to Martel in 1993 for a Propulsion means. Demonstrate here is a present invention generally relates to a propulsion apparatus for imparting thrust to a person. The propulsion apparatus is configured to be disposed or mounted on the user such that the thrust is transmitted to the rear of the user’s pelvic area. The propulsion apparatus may, for example, include a motor which is connected to a propeller for providing forward thrust. The propulsion apparatus may be used in association with skis for travelling over a snow-covered surface; however, it may be used in association with other similar or analogous devices for travel over the same or other surfaces.
G. U.S. Pat. 8,286,907 was issued to Dohi et al., in 2012 for a Flying entertainment vehicle. The device shown was an apparatus for use as a flying entertainment vehicle. The apparatus includes a lift system, such as a para wing, which is inflated by air to generate lift and further includes a vehicle frame attached to the lift system such as suspension lines that also space the lift system apart from the vehicle frame. The apparatus includes a thrust assembly supported on the vehicle frame that is operable to propel the vehicle at a flight speed at which the lift system is operated, e.g., the para wing is inflated, to generate lift to suspend the vehicle frame above the ground. The apparatus includes showing elements that may be supported on or by the vehicle frame and be configured to be lift neutral. The show elements function to distract observers away from the lift system by appearing to provide the lift or features that cause the vehicle frame to fly.
H. U.S. Pat. 2018/0272856 that was issued to Manning in 2018 is for a system named a Ducted Fan Propulsion System. Discussed and taught was a ducted fan propulsion system comprises an outer cowling, adapted to form a duct. The duct houses one or more fan blades rotating about a central axis. One or more motors are in communication with the fan blades and in communication with a power source. The duct transverses by a plurality of spokes. In an embodiment, multiple ducts are housed within an outer cowling, with each duct comprising one or more rotatable fan blades, one or more central axes, and one or more motors. In each embodiment, one or more members are attached to the ducted or multi-ducted fan propulsion system and extend to a user or vehicle. The members terminate in a handle further comprising a throttle adjuster.
I. World/ PCT application WO2013093447 submitted by Johnson et al., in 2013 for a Personal Propulsion Apparatus and Method. This is a person propulsion apparatus and method. In particular, but not exclusively, the present invention relates to an apparatus and method for use principally in sporting or physical activities, in particular so-called “extreme sports” including skateboarding, snowboarding, skiing, surfing, power kiting and the like. The present invention provides an improved means of propulsion for use by an individual when engaging in such or similar activities.
J. French Patent numbered FR2667568 and issued to Vintila in 1994 was for an individual powered flight apparatus. Presented here is an individual flight apparatus, consisting of two internal combustion engines which drive two propellers arranged in a horizontal plane. The two engines have rotation which is synchronized by four conical toothed wheels and by a shaft which is in a tube which supports the two engines and which, in its center, supports the flying harness of the pilot. On this tube there are also two vertical bars with two handles: one bar is for acceleration and the other bar is for maneuvering the apparatus in rotation, via two steerable wings. In these bars two other bars can fit telescopically, which serve as legs for the apparatus. On the bars there are two tanks.

As far as known, there are no Special electric propulsion systems to power paragliders and other small, light aircraft as described by Bitar. It is believed that this product is unique in its design and technologies. A novelty search revealed:

As can be observed, none of the prior art has anticipated or caused one skilled in the art of propulsion systems for small aircraft like para gliders to reason, consider, or conclude that this invention by Pete Bitar as obvious to a person having ordinary skill in the art of this industry. The device for a Special electric propulsion system to power paragliders and other small, light aircraft provides an answer to the problems that are shown above. The Bitar solution addresses the shortfalls and solves them, unlike previous art in this industry.

### SUMMARY OF THE INVENTION

This invention is a Special electric propulsion system to power paragliders and other small, light aircraft. Taught here are the ways a lightweight electrical propulsion system can be connected and propel a lightweight aircraft or wing in an efficient and economical manner.

The preferred embodiment of the special Electric Propulsion System to power paragliders and other aircraft called a CanopE-JET comprised of: (a) a frame system; (b) a ducted turbine system comprising at least one turbine with a set of blades or impellers 51 of the fan/turbine, a shroud/exterior protection and frame of the turbine/fan0, a cut protector on shroud, a means to secure shroud and support to seat frame, and an electric motor of the Special Electric Propulsion System with shaft connected to blades; (c) a seat assembly comprised of a seat, an arm rest frame, a seat back, a structural support on seat and components, a set of components, a seat belt holds a user to seat, a pair of shoulder straps to hold user, a means for connecting belt and straps to seat structure, a means for connecting seat, seat back and arm rests to seat structure; (d) a power system comprising a set of rechargeable batteries, a set of battery boxes, a wiring harness from batteries to motors, a means for removably connecting battery box and wiring harness to seat structure, a recharge plug to rechargeable batteries from recharging power source, and a recharging power source to utility receptacle, solar panels on airfoil or on ground stand, or wired system generator; (e) a servo-throttle for powering motor of the Special Electric Propulsion System comprising a handle grip, a spring switch to throttle/ engage the electric power from battery to motor, a wiring cable/conduction/harness, a set of connectors from the set of batteries to the motor; and (f) a system to attach the frame to an aircraft including a harness from seat assembly to the aircraft such as a paraglider with user/operator, a pair of eyelets on the frame for harness, and a means for removably securing eyelets to harness. The newly invented Special electric propulsion system to power paragliders and other small, light aircraft for various applications may be manufactured at low volumes by very simple means and in high volume production by more complex and controlled systems.

### OBJECTS AND ADVANTAGES

There are several objects and advantages of the Special electric propulsion system to power paragliders and other small, light aircraft. There are currently no known propulsion devices or systems that are effective at providing the objects of this invention. The special electric propulsion system - The CanopE-Jet concept- is one that allows for the following benefits over conventional, gas-powered, paramotor or other wearable powered-paraglider propulsion systems:

| Item | Advantages |
|---|---|
| 1 | Lighter weight due to lighter electric motors than gas-powered systems; |
| 2 | No fuel; |
| 3 | No Greenhouse Gas emissions; |
| 4 | All Electric with battery or solar powered (withpotential for solar cells embedded into the top of the paraglider/wing); |
| 5 | No combustion noise, has a jet sound; |
| 6 | No large fan or propeller to create danger to the occupant, paraglider lines, or other elements of the craft. Also, less likely to pick up FOD or other external elements that can get sucked into the engines; |
| 7 | Small enough to put in a standard car seat, trunk, or rear of an SUV without needing to fold seats down, or to break down the craft to fit in a ground vehicle, the craft can fit in a footprint of no more than 45 inches in width, height, or depth; |
| 8 | Rapid setup for launch and rapid start (no pull-starting, priming, or other pre-start actions needed to start the motor); |
| 9 | Faster potential airspeed, limited only by the speed limitation of the wing/paraglider, with potential, theoretical speeds of over 300 mph. Over 70 mph possible with properly trimmed paraglider wings; |
| 10 | Smooth, low-vibration operation; |
| 11 | Ducted turbines with protected intakes and more than one ducted fan/turbine arrayed with counter-rotating propellers/turbines; |
| 12 | Easily wearable by one person with potential for tandem/two-person operations; and |
| 13 | Simple, servo-controller-based throttle to control Electronic Speed Controllers (ESCs) which drive electric motors. |

Finally, other advantages and additional features of the present Special electric propulsion system to power paragliders and other small, light aircraft will be more apparent from the accompanying drawings and from the full description of the device. For one skilled in the art of propulsion devices for small aircraft and the like, it is readily understood that the features shown in the examples with this product are readily adapted to other types of electrical propulsion systems and devices.

### DESCRIPTION OF THE DRAWINGS - FIGURES

The accompanying drawings, which are incorporated in and constitute a part of this specification, illustrate an embodiment of the Special electric propulsion system called CanopE-Jet to power paragliders and other small, light aircraft that is preferred. The drawings together with the summary description given above and a detailed description given below explain the principles of the Special electric propulsion system. It is understood, however, that the electrical propulsion system is not limited to only the precise arrangements and instrumentalities shown.

FIGS. 1 A through 1 Eare sketches of the general Special Electric Propulsion System to power paragliders and other aircraft called a CanopE-JET for aircraft applications.

FIGS. 2 A through 2 Dare sketches of the general Special Electric Propulsion System to power paragliders and other aircraft called a CanopE-JET device from different views with components and features noted.

FIGS. 3 A through 3 Dare more sketches of the general Special Electric Propulsion System to power paragliders and other aircraft called a CanopE-JET with the components and features shown.

FIGS. 4 A through 4 Eare side and back views of the Special Electric Propulsion System to power paragliders and other aircraft called a CanopE-JET. FIG. 4 Dshows portability and FIG. 4 E shows configurations for the framework.

FIGS. 5 A through 5 Dare sketches of the Special Electric Propulsion System to power paragliders and other aircraft called a CanopE-JET with general components and features noted.

FIGS. 6 A through 6 Fare up close drawings of the propulsion system fan systems and sketches of the servo throttle to control the thrusts.

FIGS. 7 A through 7 Care sketches of the Special Electric Propulsion System to power paragliders and other aircraft called a CanopE-JET with the user/operator.

FIGS. 8 A through 8 Eare sketches of a paraglider in operation.

FIGS. 9 A through 9 Care sketches of a gas-powered fan and propulsion unit with a paraglider.

FIGS. 10 A through 10 Fare sketches of prior art for small aircraft propulsion systems.

### DESCRIPTION OF THE DRAWINGS — REFERENCE NUMERALS

The following list refers to the drawings: Table B: Reference numbers

| Ref # | Description |
|---|---|
| 30 | special Electric Propulsion System 30 to power paragliders 120 and other aircraft called a CanopE-JET |
| 31 | fan arrangement 31 with a single fan 78 in each shroud 50, 55 |
| 33 | fan arrangement 33 with a group of three fans 78 in each shroud 50, 55 |
| 34 | fan arrangement 34 with a group of four fans 78 in each shroud 50, 55 |
| 35 | sketches 35 of the Special Electric Propulsion System 30 |
| 38 | Structural connection between Electric Propulsion System 30 to enable cluster systems - 4 fan, 8 fan and the like |
| 50 | turbine turbines electric fan 50 of the Special Electric Propulsion System 30 |
| 51 | blades or impellers 51 of fan/turbine 50 |
| 55 | shroud / exterior protection and frame 55 of the turbine/fan 50 |
| 55A | cut protector 55A on shroud 55 |
| 56 | means 56 to secure shroud 55 and support 59 to seat frame 71 such as fasteners, molding, casting, |
| | welding, brazing, adhesives, or the like |
| 58 | group of shafts, motor cone, and bearings 58 of turbine 50 |
| 59 | axial supports 59 and motor support ring 59A |
| 59A | motor support ring 59A |
| 59B | means to connect together 59B shroud 55, supports 59 and ring 59A such as fasteners, molding, casting, welding, brazing, adhesives, or the like |
| 60 | seat 60 |
| 61 | arm rest frame 61 |
| 62 | back 62 |
| 63 | structural support 63 on seat 60 and components 64 |
| 64 | components 64 |
| 65 | seat belt 65 holds user 100 to seat 60 |
| 66 | shoulder straps 66 to hold user 100 |
| 67 | means for connecting 67 belt 65 and straps 66 to seat structure 71 — fasteners, clips, rings, cable ties, adhesives |
| 68 | means for connecting 68 seat 60, seat back 62 and arm rests 63 to seat structure 71 — fasteners, clips, rings, cable ties, adhesives, weld, braze, cold casting, etc. |
| 70 | battery platform 70 |
| 71 | structure 71 from seat 60 to platform 70 |
| 72 | a means for connecting 72 platform 70 and structure 71 — fasteners, clips, rings, cable ties, adhesives, weld, braze, cold/casting as one piece, molding if |
| | plastic or composite |
| 74 | set of rechargeable batteries 74 |
| 75 | battery boxes 75 |
| 76 | wiring harness 76 from batteries 74 to motors 78 |
| 77 | means for removably connecting 77 battery box 75 and wiring harness 76 to seat structure 71 — fasteners, clips, rings, cable ties, adhesives |
| 78 | electric motor 78 of the Special Electric Propulsion System 30 with shaft 58 connected to blades 51 |
| 79 | recharge plug 79 to rechargeable batteries 74 from recharging power source 89 |
| 80 | servo-throttle 80 for powering motor of the Special Electric Propulsion System 30 |
| 81 | handle grip 81 |
| 82 | spring switch 82 to throttle/ engage the electric power from battery 75 to motor 78 |
| 83 | wiring cable/conduction/harness 83 |
| 85 | connectors 85 from batteries 75 to motor 78 |
| 89 | recharging power source 89 to utility receptacle, solar panels on airfoil or on ground stand, or wired system generator |
| 90 | harness 90 from seat assembly to aircraft 120 such as a paraglider 120A with user/operator 100 |
| 91 | eyelets 91 secured on the on the frame 71 for harness 90 |
| 92 | means 92 for removably securing eyelets 91 to harness 90 such as carabiner, clips, rings, fasteners, or equal |
| 100 | user/operator 100 of the Special Electric Propulsion System 30 |
| 115 | gas powered propulsion system 115 |
| 120 | aircraft 120 or vehicles for the use with the Special Electric Propulsion System 30 such as Paragliders, hang gliders, para-wings, wingsuits, human-portable lifting wing, lift devices with multiple, electric, ducted fans, and lift devices with electric jet turbines |
| 120A | paraglider 120 |
| 300 | prior Art 300 U.S. Pat. 8,894,015 Contoret 2014 APPARATUS AND METHOD FOR PARAGLIDERS |
| 310 | prior Art 310 U.S. Pat. 8,292,678 Burgess, Jr. -2012 PERSONAL PROPULSION DEVICE WITH HANDS FREE CONTROL |
| 320 | prior Art 320 French Patent 90-12452 VINTILA. — 1990 Apparel for Air Propulsion |
| 330 | prior Art 330 U.S. Pat. 5,222,569 - Martel - 1993 -PROPULSION MEANS |
| 340 | prior Art 340 U.S. Pat. Appn. 2018/0272856 Manning —2018 DUCTED FAN PROPULSION SYSTEM |
| 350 | prior Art 350 U.S. Pat. 8,286,907 2012 - Dohi et al. FLYING ENTERTAINMENT VEHICLE |

### DETAILED DESCRIPTION OF PERFERRED EMBODIMENT

This invention relates to a Special electric propulsion system called a CanopE-Jet to power paragliders and other small, light aircraft. Particularly this relates to an apparatus and system for paragliders. As an improved means of propulsion for use by an individual when engaging in paragliding, powered paragliding, paramotoring, hang gliding, and other similar sporting activities. This relates to propulsion arrangements which can be secured to the pilot or seat for a pilot, and which gives the pilot controllable powered flight. This is a personal air propulsion device for use by an individual. This could be used with snow skiing, skating, bicycling, or so-called “extreme sports” including skateboarding, snowboarding, surfing, power kiting and the like. The system relates, in general, to the use of fans to provide thrust for transportation systems and enabling component designs for vehicles such as ultralight aircraft, and, more particularly, to a flying entertainment vehicle. This invention relates to such devices that provide for hands-free operation and control of the device and are configured to accept adjustments for versatility. The multiple electric thrusters ducted fans can be made of carbon fiber for light weight and strength but can also be fabricated from a variety of other materials and the CanopE-Jet can fly for several minutes per charge, depending on the number of rechargeable batteries and energy density of the batteries being carried.

The advantages for a Special electric propulsion system 30 called a CanopE-Jet to power paragliders and other small, light aircraft device 30 are listed above in the introduction. Succinctly the benefits are that the device:
A. Lighter weight due to lighter electric motors than gas-powered systems;
B. No fuel;
C. No Greenhouse Gas emissions;
D. All Electric with rechargeable battery or solar powered (with solar cells embedded into the top of the paraglider/wing);
E. No combustion noise, has a jet sound;
F. No large fan or propeller to create danger to the occupant, paraglider lines, or other elements of the craft. Also, less likely to pick up FOD or other external elements that can get sucked into the engines;
G. Small enough to put in a standard car seat, trunk, or rear of an SUV without needing to fold seats down, or to break down the craft to fit in a ground vehicle, the craft can fit in a footprint of no more than 45 inches in width, in height, and in depth;
H. Rapid setup for launch and rapid start (no pull-starting, priming, or other pre-start actions needed to start the motor);
I. Faster potential airspeed, limited only by the speed limitation of the wing/paraglider, with potential, theoretical speeds of over 300 mph. Over 70 mph possible with properly trimmed paraglider wings;
J. Smooth, low-vibration operation;
K. Ducted turbines with protected intakes and more than one ducted fan/turbine arrayed with counter-rotating propellers/turbines;
L. Easily wearable by one person with potential for tandem/two-person operations; and
M. Simple, servo-controller-based throttle to control Electronic Speed Controllers (ESCs) which drive electric motors.

The preferred embodiment of the special Electric Propulsion System 30 to power paragliders 120 and other aircraft called a CanopE-JET comprised of: (a) a frame system 70, 71, 72; (b) a ducted turbine system comprising at least one turbine 50 with a set of blades or impellers 51 of the fan/turbine 50, a shroud/ exterior protection and frame 55 of the turbine/fan 50, a cut protector 55A on shroud 55, a means 56 to secure shroud 55 and support 59 to seat frame 71, and an electric motor 78 of the Special Electric Propulsion System 30 with shaft 58 connected to blades 51; (c) a seat assembly comprised of a seat 60, an arm rest frame 61, a seat back 62, a structural support 63 on seat 60 and components 64, a set of components 64, a seat belt 65 holds a user 100 to seat 60, a pair of shoulder straps 66 to hold user 100, a means for connecting 67 belt 65 and straps 66 to seat structure 71, a means for connecting 68 seat 60, seat back 62 and arm rests 63 to seat structure 71; (d) a power system comprising a set of rechargeable batteries 74, a set of battery boxes 75, a wiring harness from batteries 74 to motors 78, a means for removably connecting 77 battery box 75 and wiring harness 76 to seat structure 71, a recharge plug 79 to rechargeable batteries 74 from recharging power source 89, and a recharging power source 89 to utility receptacle, solar panels on airfoil or on ground stand, or wired system generator; (e) a servo-throttle 80 for powering motor of the Special Electric Propulsion System 30 comprising a handle grip 81, a spring switch 82 to throttle/engage the electric power from battery 75 to motor 78, a wiring cable/conduction/harness 83, a set of connectors 85 from the set of rechargeable batteries 75 to the motor 78; and (f) a system to attach the frame 71 to an aircraft 120 including a harness 90 from seat assembly to the aircraft 120 such as a paraglider 120A with user/operator 100, a pair of eyelets 91 on the frame 71 for harness 90, and a means 92 for removably securing eyelets 91 to harness 90.

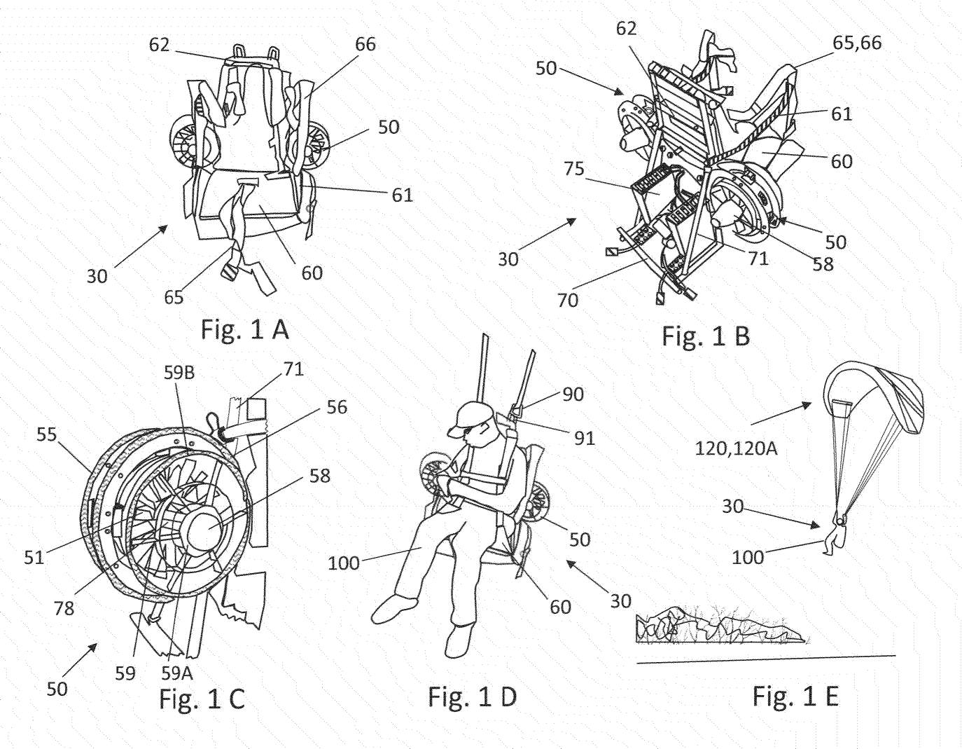

There is shown in FIGS. 1-10 a complete description and operative embodiment of the Special electric propulsion system 30 to power paragliders and other small, light aircraft. In the drawings and illustrations, one notes well that the FIGS. 1-10 demonstrate the general configuration and use of this product. The various example uses are in the operation and use section, below.

The accompanying drawings, which are incorporated in and constitute a part of this specification, illustrate an embodiment of the Special electric propulsion system 30 to power paragliders and other small, light aircraft that is preferred. The drawings together with the summary description given above and a detailed description given below explain the principles of the Special electric propulsion system 30. It is understood, however, that system 30 is not limited to only the precise arrangements and instrumentalities shown. Other examples of propulsion systems for small aircraft are still understood by one skilled in the art of this industry to be within the scope and spirit shown here.

FIGS. 1 A through 1 Eare sketches of the general Special Electric Propulsion System 30 to power paragliders and other aircraft called a CanopE-JET for aircraft applications. Demonstrated in these drawings are: a special Electric Propulsion System 30 to power paragliders 120 and other aircraft called a CanopE-JET; a turbine or turbines of electric fan 50 of the Special Electric Propulsion System 30; a set of blades or impellers 51 of fan/turbine 50; a shroud/exterior protection and frame 55 of the turbine/fan 50; a cut protector 55A on shroud 55; a means 56 to secure shroud 55 and support 59 to seat frame 71; a group of a drive shaft, motor cone, and bearings 58 of turbine/ or turbines of electric fan 50; an axial support 59; a motor support ring 59A; a means to connect together 59B shroud 55, supports 59 and ring 59A such as fasteners, molding, casting, welding, brazing, adhesives, or the like; a seat 60; an arm rest frame 61; a back 62; a structural support 63 on seat 60 and components 64; a seat belt 65 holds user 100 to seat 60; a pair of shoulder straps 66 to hold user 100; a battery platform 70; a structure 71 from seat 60 to platform 70; an electric motor 78 of the Special Electric Propulsion System 30 with shaft 58 connected to blades 51; a harness 90 from seat 95 to aircraft 120 such as a paraglider 120A with user/operator 100; an user/operator 100 of the Special Electric Propulsion System 30; and an aircraft 120 or vehicles for the use with the Special Electric Propulsion System 30 such as Paragliders, hang gliders, para-wings, wing-suits, human-portable lifting wing, lift devices with multiple, electric, ducted fans, and lift devices with electric jet turbines; a paraglider 120.

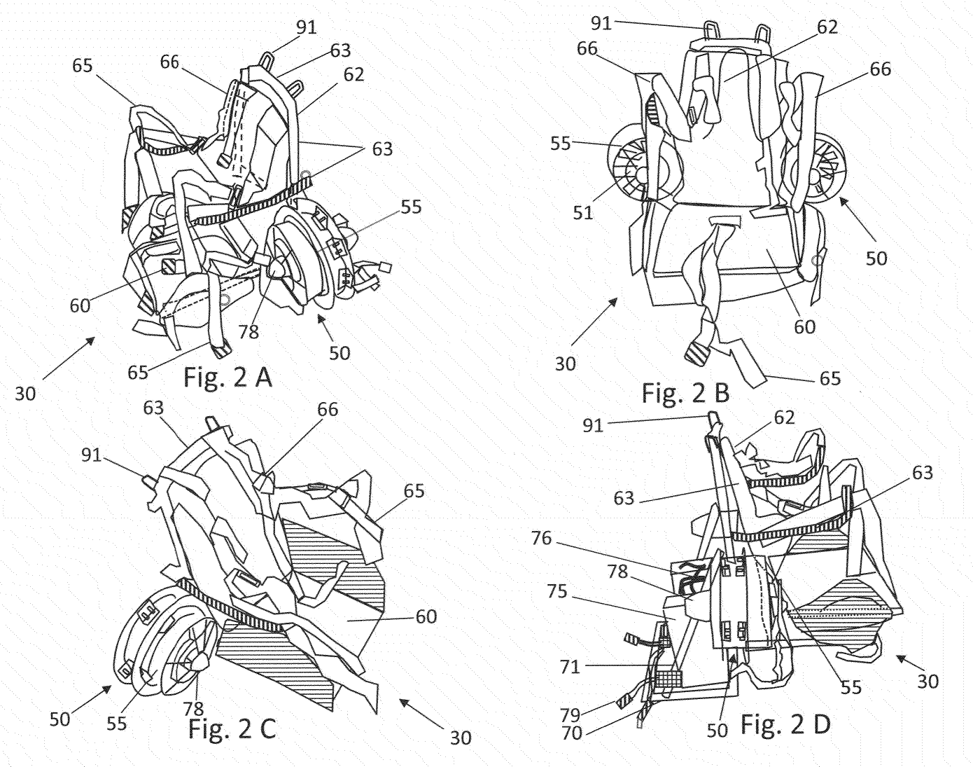

FIGS. 2 A through 2 Dare sketches of the general Special Electric Propulsion System 30 to power paragliders and other aircraft called a CanopE-JET device from different views with components and features noted. Provided in these drawings are these components: a special Electric Propulsion System 30 to power paragliders 120 and other aircraft called a CanopE-JET; turbine or turbines of electric fan 50 of the Special Electric Propulsion System 30; a set of blades or impellers 51 of fan/turbine 50; a shroud/ exterior protection and frame 55 of the turbine/fan 50; a seat 60; an arm rest frame 61; a back 62; a structural support 63 on seat 60 and components 64; a pair of shoulder straps 66 to hold user 100; a battery platform 70; a structure 71 from seat 60 to platform 70; a set of battery boxes 75; a wiring harness 76 from batteries 74 to motors 78; an electric motor 78 of the Special Electric Propulsion System 30 with shaft 58 connected to blades 51; a recharge plug 79 to batteries 74 from recharging power source 89; and a pair of eyelets 91 secured on the frame 71 for harness 90.

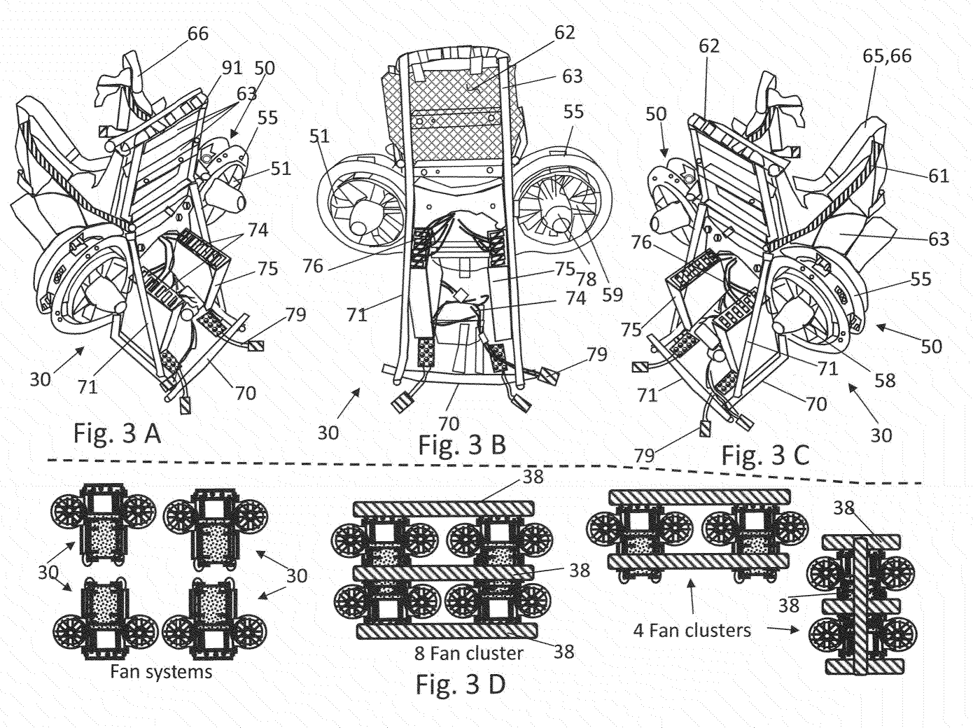

FIGS. 3 A through 3 D are more sketches of the general Special Electric Propulsion System 30 to power paragliders and other aircraft called a CanopE-JET with the components and features shown. Shown here are: a special Electric Propulsion System 30 to power paragliders 120 and other aircraft called a CanopE-JET; a turbine or turbines of electric fan 50 of the Special Electric Propulsion System 30; a set of blades or impellers 51 of fan/turbine 50; a shroud/ exterior protection and frame 55 of the turbine/fan 50; a group of a drive shaft, motor cone, and bearings 58 of turbine/ or turbines of electric fan 50; an arm rest frame 61; a back 62; a structural support 63 on seat 60 and components 64; a seat belt 65 holds user 100 to seat 60; a pair of shoulder straps 66 to hold user 100; a battery platform 70; a structure 71 from seat 60 to platform 70; a set of rechargeable batteries 74; a set of battery boxes 75; a wiring harness from batteries 74 to motors 78; and a recharge plug 79 to batteries 74 from a recharging power source 89. FIG. 3D is a cluster arrangement described below.

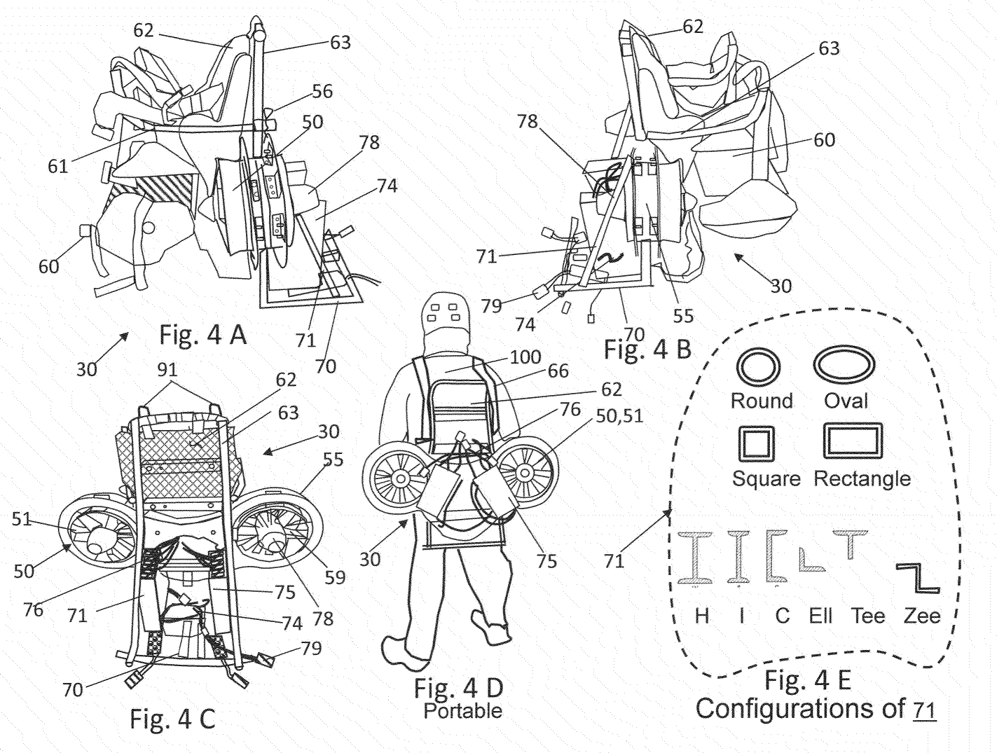

FIGS. 4 A through 4 Dare side and back views of the Special Electric Propulsion System 30 to power paragliders and other aircraft called a CanopE-JET. Provided in these drawings are: a special Electric Propulsion System 30 to power paragliders 120 and other aircraft called a CanopE-JET; a turbine or turbines of electric fan 50 of the Special Electric Propulsion System 30; a set of blades or impellers 51 of fan/turbine 50; a shroud/ exterior protection and frame 55 of the turbine/fan 50; a seat 60; an arm rest frame 61; a back 62; a structural support 63 on seat 60 and components 64; a battery platform 70; a structure 71 from seat 60 to platform 70; a set of rechargeable batteries 74; a set of battery boxes 75; a wiring harness 76 from batteries 74 to motors 78; and a recharge plug 79 to batteries 74 from recharging power source 89. FIG. 4 Dshows the portability once the unit is folded. The unit is easily portable and wearable by one person. FIGS. 4 E shows the various configurations for the framework 71 -see anticipated materials and configurations, below.

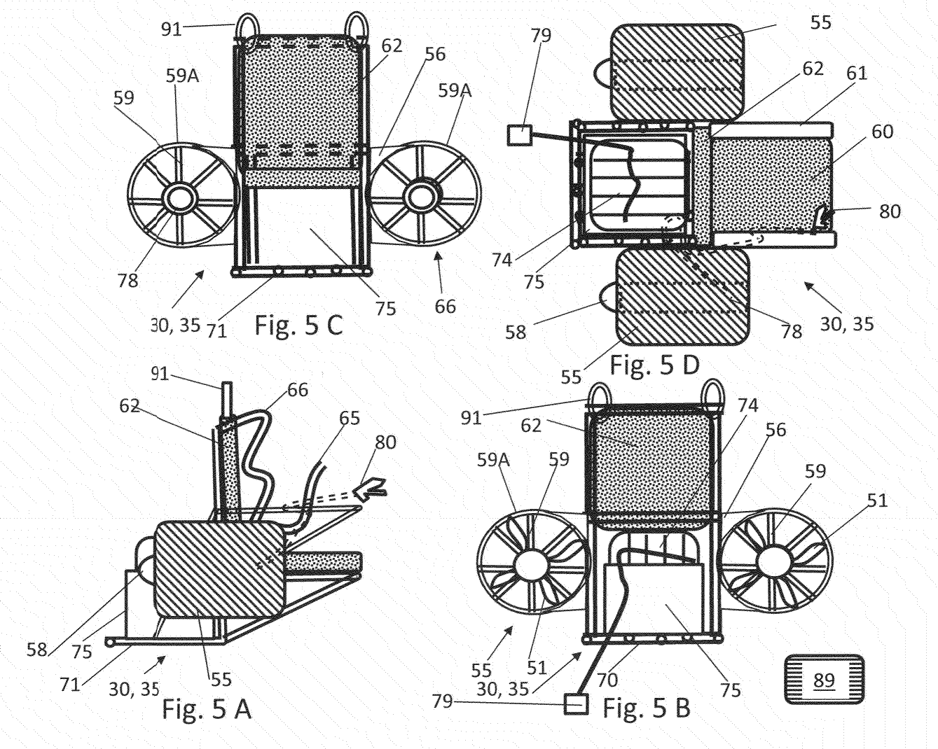

FIGS. 5 A through 5 D are sketches 35 of the Special Electric Propulsion System 30 to power paragliders 120A and other aircraft 120 called a CanopE-JET with general components and features noted. Demonstrated are: a special Electric Propulsion System 30 to power paragliders 120 and other aircraft called a CanopE-JET; sketches 35 of the Special Electric Propulsion System 30; a turbine or turbines of electric fan 50 of the Special Electric Propulsion System 30; a set of blades or impellers 51 of fan/turbine 50; a shroud/exterior protection and frame 55 of the turbine/fan 50; a means 56 to secure shroud 55 and support 59 to seat frame 71; an axial support 59; a seat 60; an arm rest frame 61; a back 62; a structural support 63 on seat 60 and components 64; a set of components 64; a seat belt 65 holds user 100 to seat 60; a pair of shoulder straps 66 to hold user 100; a means for connecting 67 belt 65 and straps 66 to seat structure 71 —fasteners, clips, rings, cable ties, adhesives; a means for connecting 68 seat 60, seat back 62 and arm rests 63 to seat structure 71 — fasteners, clips, rings, cable ties, adhesives; a battery platform 70; a structure 71 from seat 60 to platform 70; a means for connecting 72 platform 70 and structure 71 —fasteners, clips, rings, cable ties, adhesives, weld, braze, or cold/casting as one piece; a set of rechargeable batteries 74; a set of battery boxes 75; a wiring harness from batteries 74 to motors 78; a means for removably connecting 77 battery box 75 and wiring harness 76 to seat structure 71 — fasteners, clips, rings, cable ties, adhesives; an electric motor 78 of the Special Electric Propulsion System 30 with shaft 58 connected to blades 51; a recharge plug 79 to batteries 74 from recharging power source 89; a servo-throttle 80 for powering motor of the Special Electric Propulsion System 30; a handle grip 81; a spring switch 82 to throttle/ engage the electric power from battery 75 to motor 78; a wiring cable/conduction/harness 83; a set of connectors 85 from batteries 75 to motor 78; a recharging power source 89 to utility receptacle, solar panels on airfoil or on ground stand, or wired system generator; a pair of eyelets 91 on frame 71 for harness 90; and a means 92 for removably securing eyelets 91 to harness 90 such as carabiner, clips, rings, fasteners, or equal. In the FIGS. 5 A through 5 D, the structure cross sections, and some Interconnections and means for securing not shown but Well understood by an ordinary person skilled in the art - items like 56, 59A, B, 67, 68, 72, 77,and 92.

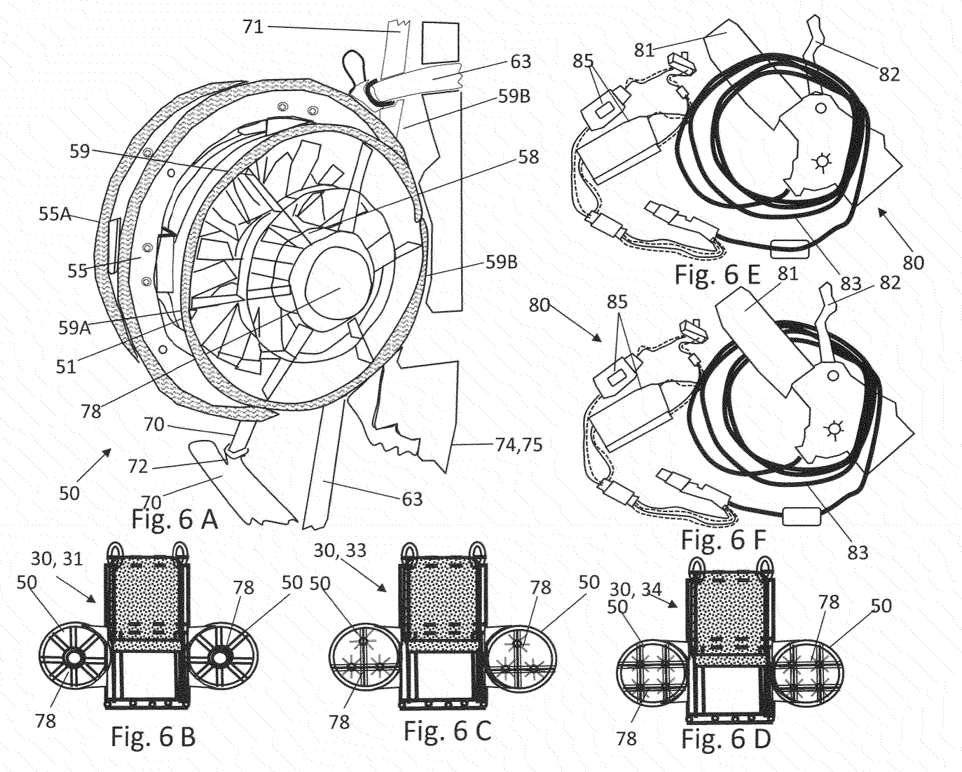

FIGS. 6 A through 6 Fare up close drawings of the multi fan propulsion systems 50 and sketches of the servo throttle 80 to control the thrusts. Demonstrated are: a special Electric Propulsion System 30 to power paragliders 120 and other aircraft called a CanopE-JET; a turbine or turbines of electric fan 50 of the Special Electric Propulsion System 30; a set of blades or impellers 51 of fan/turbine 50; a shroud/ exterior protection and frame 55 of the turbine/fan 50; a cut protector 55A on shroud 55; a means 56 to secure shroud 55 and support 59 to seat frame 71; a group of a drive shaft, motor cone, and bearings 58 of turbine/ or turbines of electric fan 50; an axial support 59; a motor support ring 59A; a means to connect together 59B shroud 55, supports 59 and ring 59A such as fasteners, molding, casting, welding, brazing, adhesives, or the like; a battery platform 70; a structure 71 from seat 60 to platform 70; a means for connecting 72 platform 70 and structure 71 - fasteners, clips, rings, cable ties, adhesives, weld, braze, or cold/casting as one piece; an electric motor 78 of the Special Electric Propulsion System 30 with shaft 58 connected to blades 51; a servo-throttle 80 for powering motor of the Special Electric Propulsion System 30; a handle grip 81; a spring switch 82 to throttle/ engage the electric power from battery 75 to motor 78; a wiring cable/conduction/harness 83; and a set of connectors 85 from batteries 75 to motor 78. Drawing FIG. 6 B, C and D demonstrate fan arrangement 31 with a single fan 78 in each shroud 50, 55; fan arrangement 33 with a group of three fans 78 in each shroud 50, 55; and fan arrangement 34 with a group of four fans 78 in each shroud 50, 55. These are to show the ability to group clusters of fans within shrouds. These are examples and not limitations to the Special Electric Propulsion System 30 to power paragliders 120A and other aircraft 120 called a CanopE-JET.

This invention uses electric “jets”, or ducted fans using a Coanda effect to accelerate air through a shaped duct, in order to amplify thrust, reduce power usage, and/or increase the performance of the propulsion system - all WITHOUT the need for a protective propeller ring as the ducted turbines or propellers would be inaccessible to the paraglider lines. Note: The Coandă effect is the tendency of a jet of fluid emerging from an orifice to follow an adjacent flat or curved surface and to entrain fluid from the surroundings so that a region of lower pressure develops. The Romanian inventor Henri Coandă, was the first to described it as “the tendency of a jet of fluid emerging from an orifice to follow an adjacent flat or curved surface and to entrain fluid from the surroundings so that a region of lower pressure develops″. Coandă was the first to recognize the practical application of the phenomenon in aircraft design.

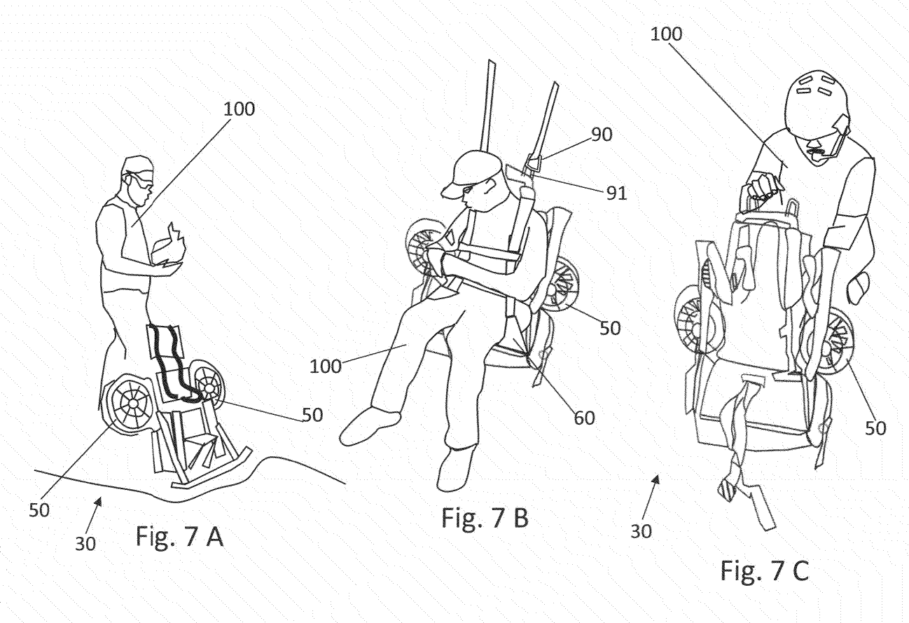

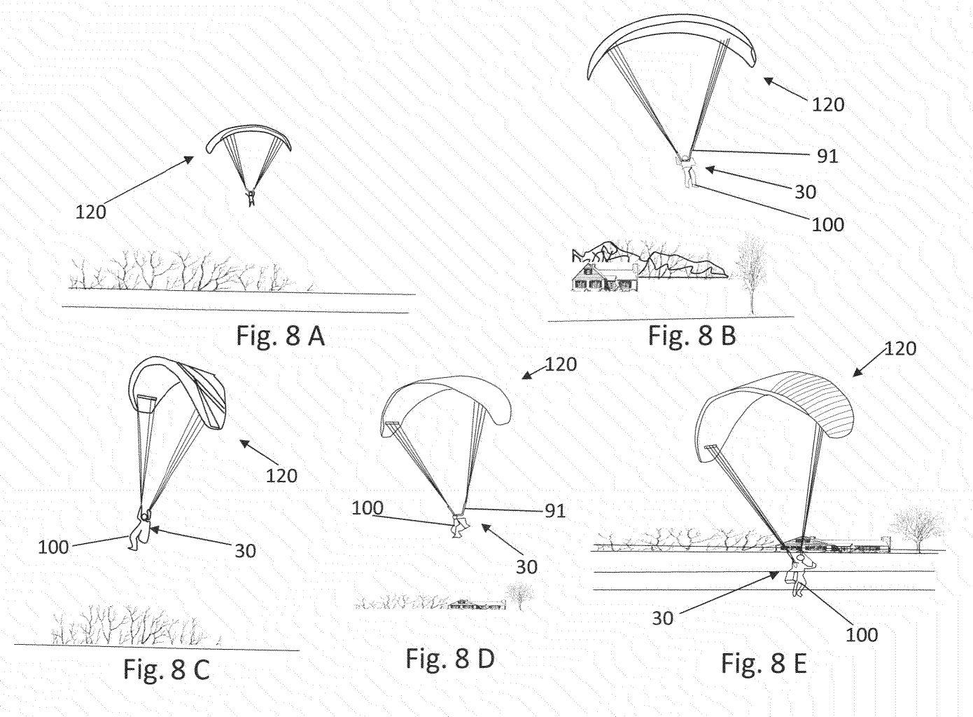

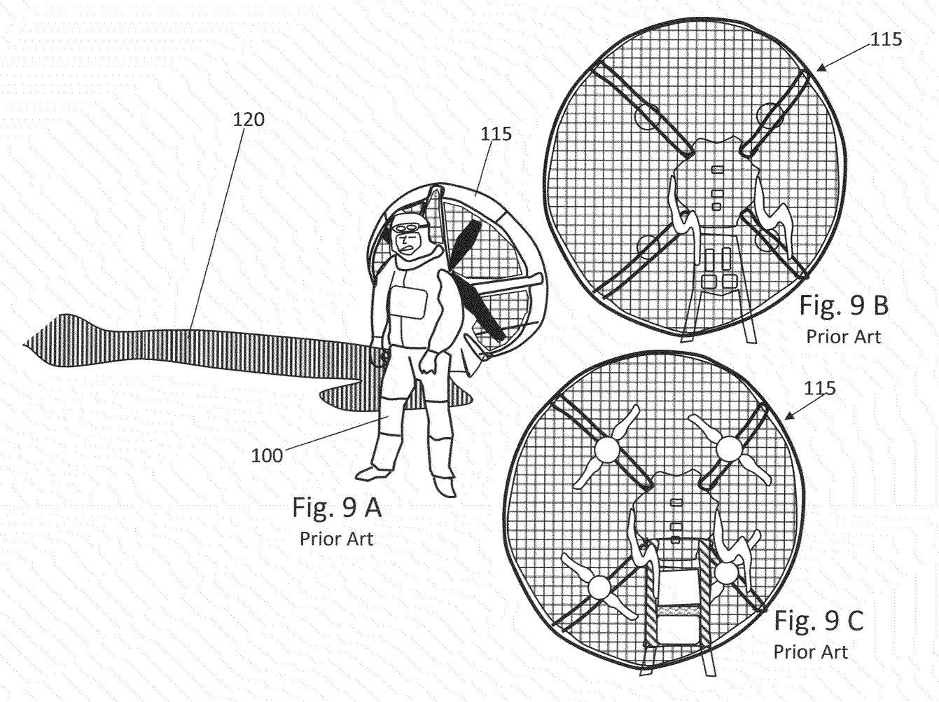

FIGS. 7 A through 7 Care sketches of the Special Electric Propulsion System to power paragliders and other aircraft called a CanopE-JET with the user/operator. FIGS. 8 A through 8 E are sketches of a paraglider in operation. FIGS. 9A through 9 C are sketches of a gas-powered fan and propulsion unit with a paraglider. These are discussed in the Operations section, below.

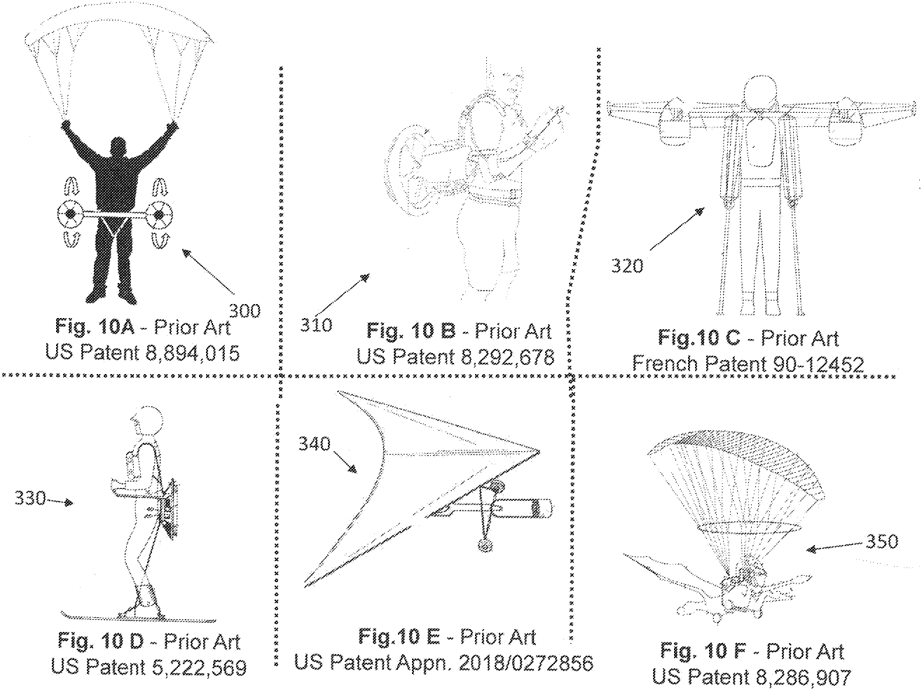

FIGS. 10 A through 10 F are sketches of prior art for small aircraft propulsion systems. These include: prior Art 300 Prior Art U.S. Pat. 8,894,015 Contoret 2014 APPARATUS AND METHOD FOR PARAGLIDERS; Prior Art 310 U.S. Pat. 8,292,678 Burgess, Jr. — 2012 PERSONAL PROPULSION DEVICE WITH HANDS FREE CONTROL; Prior Art 320 French Patent 90-12452 VINTILA. — 1990 Apparel for Air Propulsion; Prior Art 330 U.S. Pat. 5,222,569 — Martel — 1993 - PROPULSION MEANS; Prior Art 340 U.S. Pat. Appn. 2018/0272856 Manning — 2018 DUCTED FAN PROPULSION SYSTEM; and Prior Art 350 U.S. Pat. 8,286,907 2012 — Dohi et al. — FLYING ENTERTAINMENT VEHICLE. As can be seen, the small aircraft propulsion system called CanopE Jet 30 is both a unique combination and use as described herein.

The anticipated materials for the small aircraft propulsion system 30 called CanopE Jet include: a group of fabric material for the safety belts 65, 66 and harnesses 91 can be nylon, rayon, cotton, polyester, leathers, vinyl, and synthetic or non-synthetic composite materials. The characteristics preferred are: a fabric which is flexible, comfortable, strong, cut-resistant, lightweight, and easy to clean. The method to attach 67 the belts and harnesses to the frame 71 or to each other may be sewing, clips, rivets, or various fasteners. The frame structures 70, 71 may be of a variety of configurations. For example, and not as a limitation, the structures may be tubular (round, oval, square, rectangular, or other regular or non-regular polygonal cross-sections); the structures may be angles, Zees, Tees, “I” or wide flange (“W” or “H”) or other cross-sections not specifically identified. The materials for example and not limitation may be a metal like steel, a steel alloy, aluminum, titanium, a composite plastic or any other light weight, durable material. The propellers 51 may be a metal such as steel, steel alloy, aluminum, titanium; a composite material; a wood laminate, or other durable, light weight yet sufficiently sturdy material. Propellers are well known in the art of aircraft and may be selected from a plethora of styles and materials. The other components are likewise expected to be of lightweight, strong, and durable materials shaped to appropriate configurations. However, these are exemplary and lot limitations to other means which are well within the spirit and scope of the full embodiment of system 30.

The entire propeller driven system, as just described, rotates around the fixed shaft which can have an aperture (hollow opening) throughout its center. The various control wiring is often guided along and through the structure as is well known in the art of lightweight aircraft. Also, a mount for the motor(s) 78 are normally retained by a collar to the shaft. The battery (ies) 74 are connected through cables 76 to the motor(s). The electric power from the battery powers the motor which transforms the stored electrical energy into kinetic energy and rotational power. This power is further transferred to the propellers and the system shown or a functional equivalent. The motors 78 have relatively simple controls 80 as one skilled in the art of electromechanical power systems well appreciates. An optional remote-control system may be employed for using the system 30 as drone, non-human pilot-controlled aircraft if desired. This remote system is also well known to those skilled in the art of electrical and electronic remote-control systems. This remote control operation could be used to group multiple units together and control from a central system. Thereby, several propulsion systems could be embodied as a cluster and then attached to a larger payload and/ or larger canope/ paraglider wing 120, 120A. Multiple units of the special Electric Propulsion System 30 to power paragliders 120 and other aircraft called a CanopE-JET are configured together to enable clusters. A Structural connection 38 is attached between Electric Propulsion System 30 is removably attached with straps to make a 4, 8, or multiple cluster systems of the propulsion system for larger payloads and for larger canopes. The structural connection 38 attached with straps, simple fasteners, cords and the like to enable cluster systems - 4 fan, 8 fan or more systems and the like. See FIG. 3D.

This system anticipates various types of rechargeable battery 74 back including but not limited to: Nickle Cadmium batteries, Nickle Metal Hydride batteries, Lithium-Ion batteries, Small and sealed lead acid batteries. These may be Absorbed glass mat (AGM) battery or gel battery (“gel cell”). Other experimental types include Lithium sulfur, Sodium-ion, Thin film lithium, Zinc-bromide, Zinc-cerium, Vanadium redox, Sodium-sulfur, Molten salt, and Silver-zinc. One skilled in the art of rechargeable batteries also anticipates and fully expects other battery types to be developed which will function well and be within the scope and breadth of this invention.

The details mentioned here are exemplary and not limiting. Other specific components and manners specific to describing a Special electric propulsion system 30 to power paragliders and other small, light aircraft may be added as a person having ordinary skill in the field of the art of propulsion systems for small aircraft well appreciates.

### Operation of the Preferred Embodiment

The Special electric propulsion system 30 to power paragliders and other small, light aircraft has been described in the above embodiment. The manner of how the device operates is described below. One notes well that the description above and the operation described here must be taken together to fully illustrate the concept of the Special electric propulsion system to power paragliders and other small, light aircraft. The preferred embodiment of the special Electric Propulsion System 30 to power paragliders 120 and other aircraft called a CanopE-JET comprised of: (a) a frame system 70, 71, 72; (b) a ducted turbine system comprising at least one turbine 50 with a set of blades or impellers 51 of the fan/turbine 50, a shroud/ exterior protection and frame 55 of the turbine/fan 50, a cut protector 55A on shroud 55, a means 56 to secure shroud 55 and support 59 to seat frame 71, and an electric motor 78 of the Special Electric Propulsion System 30 with shaft 58 connected to blades 51; (c) a seat assembly comprised of a seat 60, an arm rest frame 61, a seat back 62, a structural support 63 on seat 60 and components 64, a set of components 64, a seat belt 65 holds a user 100 to seat 60, a pair of shoulder straps 66 to hold user 100, a means for connecting 67 belt 65 and straps 66 to seat structure 71, a means for connecting 68 seat 60, seat back 62 and arm rests 63 to seat structure 71; (d) a power system comprising a set of rechargeable batteries 74, a set of battery boxes 75, a wiring harness from batteries 74 to motors 78, a means for removably connecting 77 battery box 75 and wiring harness 76 to seat structure 71, a recharge plug 79 to batteries 74 from recharging power source 89, and a recharging power source 89 to utility receptacle, solar panels on airfoil or on ground stand, or wired system generator; (e) a servo-throttle 80 for powering motor of the Special Electric Propulsion System 30 comprising a handle grip 81, a spring switch 82 to throttle/ engage the electric power from battery 75 to motor 78, a wiring cable/conduction/harness 83, a set of connectors 85 from the set of batteries 75 to the motor 78; and (f) a system to attach the frame 71 to an aircraft 120 including a harness 90 from seat assembly to the aircraft 120 such as a paraglider 120A with user/operator 100, a pair of eyelets 91 on the frame 71 for harness 90, and a means 92 for removably securing eyelets 91 to harness 90.

The special Electric Propulsion System 30 functions as follows: The electric fans and motors devices 50, 78 are small, lightweight and may be ducted with carbon-fiber or other lightweight material ducts. Motors are connected to electronic speed controllers and powered by batteries and then managed through a throttle 80, which is managed by a user/operator 100. The throttle balances thrust, and limits roll from side to side. By moving and pulling down on the paraglider toggles attached to the paraglider and the harness 90 connected to points 91 and mounted to the frame 71, craft 120 is controlled and directed. The frame is connected to a harness 90, in which the user 100 sits on the connected seat 60.

An additional tandem seat can be added to carry another person. The throttle 80 is squeezed in order to accelerate the thrust, and then the throttle 80 is released to reduce thrust. At takeoff, a higher throttle settings or full throttle may be required, depending on the head wind, and then lower throttle settings would be used to cruise and/or take advantage of gliding or the use of naturally occurring thermals to gain altitude.

FIGS. 7 A through 7 Care sketches of the Special Electric Propulsion System 30 to power paragliders 120A and other aircraft 120A called a CanopE-JET with the user/operator. In these use drawings are: a special Electric Propulsion System 30 to power paragliders 120 and other aircraft called a CanopE-JET; a turbine or turbines of electric fan 50 of the Special Electric Propulsion System 30; a seat 60; a harness 90 from seat 95 to aircraft 120 such as a paraglider 120A with user/operator 100; a pair of eyelets 91 on frame 71 for harness 90; and an aircraft 120 or vehicles for the use with the Special Electric Propulsion System 30 such as Paragliders, hang gliders, para-wings, wing-suits, human-portable lifting wing, lift devices with multiple, electric, ducted fans, and lift devices with electric jet turbines; a paraglider 120. One sees the user 100 ready to launch the paraglider 120 with the special Electric Propulsion System 30.

FIGS. 8 A through 8 Eare sketches of a paraglider 120A in operation. Provided here are: a special Electric Propulsion System 30 to power paragliders 120 and other aircraft called a CanopE-JET; a harness 90 from seat 95 to aircraft 120 such as a paraglider 120A with user/operator 100; an user/operator 100 of the Special Electric Propulsion System 30; and an aircraft 120 or vehicles for the use with the Special Electric Propulsion System 30 such as Paragliders, hang gliders, para-wings, wing-suits, human-portable lifting wing, lift devices with multiple, electric, ducted fans, and lift devices with electric jet turbines; a paraglider 120. One sees the aircraft 120 in various positions of flight being propelled by the special Electric Propulsion System 30.

FIGS. 9 A through 9 Care sketches of a gas-powered fan and propulsion unit 115 with a paraglider 120. Shown are: a gas-powered propulsion system 115 and an aircraft 120 or vehicles for the use with the Special Electric Propulsion System 30 such as Paragliders or hang gliders.

Many uses are anticipated for the Special electric propulsion system 30 to power paragliders and other small, light aircraft. Some examples, and not limitations, are shown in the following Table.

| ITEM | DESCRIPTION |
|---|---|
| 1 | paragliders |
| 2 | hang gliders |
| 3 | para-wings |
| 4 | wingsuits |
| 5 | human-portable lifting wing |
| 6 | lift devices with multiple, electric, ducted fans |
| 7 | lift devices with electric jet turbines |
| 8 | snow skiing |
| 9 | skating |
| 10 | bicycling |
| 11 | “Extreme sports” including skateboarding, snowboarding, surfing, power kiting and the like |
| 12 | ultralight aircraft, and, more particularly, to a flying entertainment vehicle |

With this description it is to be understood that the Special electric propulsion system 30 to power paragliders and other small, light aircraft is not to be limited to only the disclosed embodiment of product. The features of the System 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or subcombinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter’s tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it being understood that only selected embodiments have been shown and described and that all changes, modifications and equivalents that come within the spirit of the disclosures described heretofore and or/defined by the following claims are desired to be protected.

What is claimed is:

1. A special Electric Propulsion System 30 to power paragliders 120 and other aircraft called a CanopE-JET comprised of:
(a) a structural frame system (70,71,72) made of durable material;
(b) a ducted turbine system;
(c) a seat assembly;
(d) a power system;
(e) a servo-throttle 80 for powering a motor of the power system; and
(f) a system to attach the frame 71 to an aircraft 120 including a harness 90 from seat assembly to the aircraft 120 such as a paraglider 120A with user/operator 100, a pair of eyelets 91 on the frame 71 for harness 90, and a means 92 for removably securing eyelets 91 to harness 90.

2. The special Electric Propulsion System 30 to power paragliders 120 described in claim 1 wherein the system is a craft with the ability to fit in a footprint of no more than 45 inches in width, in height, and in depth.

3. The special Electric Propulsion System 30 to power paragliders 120 described in claim 1 wherein the system is an all-electric system with solar cells embedded into the top of the paraglider/wing.

4. The special Electric Propulsion System 30 to power paragliders 120 described in claim 1 wherein the system has more than one ducted fan/turbine arrayed with counter-rotating propellers/turbines into a multiple propulsion unit cluster.

5. The special Electric Propulsion System 30 to power paragliders 120 described in claim 1 wherein the system is easily portable and wearable by one person.

6. The special Electric Propulsion System 30 to power paragliders 120 described in claim 1 wherein the materials for the structural frame system (70,71,72) are selected from the group consisting of steel, steel alloy, aluminum, titanium, and a composite plastic.

7. The special Electric Propulsion System 30 to power paragliders 120 described in claim 1 wherein the configuration for the structural frame system (70,71,72) is selected from the group consisting of round tubular, oval tubular, square tubular, rectangular tubular, Ell/ angles, Zees, Tees, “I” beam, and W wide flange beam.

8. The special Electric Propulsion System 30 to power paragliders 120 described in claim 1 wherein the material for the harness 90 is selected from the group consisting of nylon, rayon, cotton, polyester, leather, vinyl, and composite materials.

9. The special Electric Propulsion System 30 to power paragliders 120 described in claim 1 wherein the ducted turbine system is comprising at least one turbine 50 with a set of blades/ impellers 51 of the fan/turbine 50, a shroud/ exterior protection and frame 55 of the turbine/fan 50, a cut protector 55A on shroud 55, a means 56 to secure shroud 55 and support 59 to seat frame 71, and an electric motor 78 of the Special Electric Propulsion System 30 with shaft 58 connected to blades 51.

10. The special Electric Propulsion System 30 to power paragliders 120 described in claim 1 wherein the seat assembly is comprised of a seat 60, an arm rest frame 61, a seat back 62, a structural support 63 on seat 60 and components 64, a set of components 64, a seat belt 65 holds a user 100 to seat 60, a pair of shoulder straps 66 to hold user 100, a means for connecting 67 belt 65 and straps 66 to seat structure 71, a means for connecting 68 seat 60, seat back 62 and arm rests 63 to seat structure 71.

11. The special Electric Propulsion System 30 to power paragliders 120 described in claim 1 wherein the power system is comprising a set of rechargeable batteries 74, a set of battery boxes 75, a wiring harness from batteries 74 to motors 78, a means for removably connecting 77 battery box 75 and wiring harness 76 to seat structure 71, a recharge plug 79 to batteries 74 from recharging power source 89.

12. The special Electric Propulsion System 30 to power paragliders 120 described in claim 1 wherein the rechargeable batteries are selected from the group consisting of consisting of Nickle Cadmium, Nickle Metal Hydride, Lithium-Ion, Small and sealed lead acid, Absorbed glass mat (AGM), Lithium sulfur, Sodium-ion, Thin film lithium, Zinc-bromide, Zinc-cerium, Vanadium redox, Sodium-sulfur, Molten salt, and Silver-zinc.

13. The special Electric Propulsion System 30 to power paragliders 120 described in claim 1 wherein the recharging power source 89 to utility receptacle is selected from the group consisting of solar panels on airfoil, solar panels on a ground stand, a system generator, and a connection to a local wired electrical power source.

14. The special Electric Propulsion System 30 to power paragliders 120 described in claim 1 wherein the servo throttle is a simple, servo-controller-based throttle to control Electronic Speed Controllers (ESCs) which in control power to the electric drive motors.

15. The special Electric Propulsion System 30 to power paragliders 120 described in claim 14 wherein the servo throttle 80 for powering the motor of the power system Special Electric Propulsion System 30 is comprising a handle grip 81, a spring switch 82 to throttle/ engage the electric power from battery 75 to motor 78, a wiring cable/conduction/harness 83, a set of connectors 85 from the set of batteries 75 to the motor 78.

16. A special Electric Propulsion System 30 to power paragliders 120 and other aircraft called a CanopE-JET comprised of:
(a) a structural frame system (70,71,72) made of durable material;
(b) a ducted turbine system comprising at least one turbine 50 with a set of blades/ impellers 51 of the fan/turbine 50, a shroud/ exterior protection and frame 55 of the turbine/fan 50, a cut protector 55A on shroud 55, a means 56 to secure shroud 55 and support 59 to seat frame 71, and an electric motor 78 of the Special Electric Propulsion System 30 with shaft 58 connected to blades 51;
(c) a seat assembly comprised of a seat 60, an arm rest frame 61, a seat back 62, a structural support 63 on seat 60 and components 64, a set of components 64, a seat belt 65 holds a user 100 to seat 60, a pair of shoulder straps 66 to hold user 100, a means for connecting 67 belt 65 and straps 66 to seat structure 71, a means for connecting 68 seat 60, seat back 62 and arm rests 63 to seat structure 71;
(d) a power system comprising a set of rechargeable batteries 74, a set of battery boxes 75, a wiring harness from batteries 74 to motors 78, a means for removably connecting 77 battery box 75 and wiring harness 76 to seat structure 71, a recharge plug 79 to batteries 74 from recharging power source 89, and a recharging power source 89 to utility receptacle, solar panels on airfoil or on ground stand, or wired system generator;
(e) a servo-throttle 80 for powering motor of the Special Electric Propulsion System 30 comprising a handle grip 81, a spring switch 82 to throttle/ engage the electric power from battery 75 to motor 78, a wiring cable/ conduction/ harness 83, a set of connectors 85 from the set of batteries 75 to the motor 78; and
(f) a system to attach the frame 71 to an aircraft 120 including a harness 90 from seat assembly to the aircraft 120 such as a paraglider 120A with user/operator 100, a pair of eyelets 91 on the frame 71 for harness 90, and a means 92 for removably securing eyelets 91 to harness 90 wherein the system is a craft with the ability to fit in a footprint of no more than 45 inches in width, in height, and in depth.

17. The special Electric Propulsion System 30 to power paragliders 120 described in claim 16 wherein the materials for the structural frame system (70,71,72) are selected from the group consisting of steel, steel alloy, aluminum, titanium, and a composite plastic.

18. The special Electric Propulsion System 30 to power paragliders 120 described in claim 16 wherein the configuration of a cross-section for the structural frame system (70,71,72) is selected from the group consisting of round tubular, oval tubular, square tubular, rectangular tubular, Ell/ angles, Zees, Tees, “I” beam, and W wide flange beam.

19. The special Electric Propulsion System 30 to power paragliders 120 described in claim 16 wherein the material for the harness 90 is selected from the group consisting of nylon, rayon, cotton, polyester, leather, vinyl, and composite materials.

20. The special Electric Propulsion System 30 to power paragliders 120 described in claim 16 wherein the rechargeable batteries are selected from the group consisting of Nickle Cadmium, Nickle Metal Hydride, Lithium-Ion, Small and sealed lead acid, Absorbed glass mat (AGM), Lithium sulfur, Sodium-ion, Thin film lithium, Zinc-bromide, Zinc-cerium, Vanadium redox, Sodium-sulfur, Molten salt, and Silver-zinc.
